(19) United States
(12) Patent Application Publication
(10) Pub. No.: US 2022/0274607 A1
(43) Pub. Date: Sep. 1, 2022

(54) METHOD FOR OPERATING A MOTOR VEHICLE

(71) Applicant: Ford Global Technologies, LLC, Dearborn, MI (US)

(72) Inventors: Turgay Isik Aslandere, Aachen/NRW (DE); Frederik De Smet, Zonhoven (BE); Ke Fan, Würselen/NRW (DE); Daniel Roettger, Eynatten/LG (BE)

(73) Assignee: Ford Global Technologies, LLC, Dearborn, MI (US)

(21) Appl. No.: 17/671,100

(22) Filed: Feb. 14, 2022

(30) Foreign Application Priority Data
Feb. 26, 2021 (DE) 102021104738.2

(51) Int. Cl. B60W 50/00; G05B 13/02; G06N 3/04

(52) U.S. Cl. CPC B60W 50/0097; G05B 13/027; G06N 3/0445; B60W 2556/60

(57) ABSTRACT

A method for operating a motor vehicle includes acquiring current operating data in order to obtain archived operating data during an acquisition phase, evaluating the archived operational data in order to obtain labeled training data for an artificial intelligence during a simulation phase, training the artificial intelligence with the labeled training data during a training phase, and activating or deactivating an ECU or a control function (A, X) of the ECU of the motor vehicle by means of the artificial intelligence during a prediction phase.

### CROSS-REFERENCE TO RELATED APPLICATION

This patent application claims priority to German Application No. DE 102021104738.2 filed on Feb. 26, 2021, which is hereby incorporated by reference in its entirety.

### BACKGROUND

Electronic control units (ECUs) or electronic control modules (ECMs) (herein referred to as ECUs) are electronic modules which are used in motor vehicles in all conceivable electronic fields, for example to control functions of advanced driver assistance systems (ADAS). Driver assistance systems are defined as auxiliary electronic devices in motor vehicles for assisting the driver in certain driving situations. Such driver assistance systems engage semi-autonomously or autonomously in the drive (for example accelerator, brake), control (for example park-steer assist), or signaling devices of the motor vehicle, or alert the driver shortly before or during critical situations by means of suitable human-machine interfaces.

Through the use of artificial intelligence (AI), such ECUs can be designed to exhibit intelligent behavior, for example through machine learning.

Deep learning refers to a method of machine learning which uses artificial neural networks (ANNs) comprising numerous hidden layers between an input layer and an output layer.

Such deep learning approaches alone leave room for improvement for control of systems in motor vehicles. In addition, there can be challenges in replacing existing ECUs with AI-based ECUs, and it is not always possible to train AI algorithms in real traffic scenarios with ECUs that provide control functions.

U.S. Pat. No. 10,248,693 B2 discloses a method for generating simulated sensor data for training and validating acquisition models.

U.S. Pat. No. 10,678,244 B2 discloses a method for data synthesis for an autonomous control system.

U.S. Pat. No. 10,019,011 B1 discloses an autonomous vehicle comprising a machine-learning model.

US 2020/0134379 A1 discloses a method for automatically labeling driving data via analysis by means of synthesis and unmonitored domain matching.

### SUMMARY

Implementations of the present disclosure may provide a method for operating a motor vehicle, including the following steps: acquiring current operating data in order to obtain archived operating data during an acquisition phase; evaluating the archived operating data in order to obtain labeled training data for an artificial intelligence during a simulation phase; training the artificial intelligence via the labeled training data during a training phase; and activating or deactivating an ECU or a control function of the ECU of the motor vehicle by means of the artificial intelligence during a prediction phase.

The operating data are representative of time sequences of values which arise during operation of a motor vehicle. They may be cached in a cloud platform or another central memory after a wireless data transmission.

In the simulation phase, these data are used to optimize the ECU. As a result, labeled training data (labeled data) are available which are suitable for classification. The labeled training data are binary control signals which can assume only the values of logical one and logical zero. In this case, the value of logical one stands for an activated ECU or an activated control function of this ECU, while the value of logical zero stands for a deactivated ECU or a deactivated control function of this ECU.

Via the labeled training data, an artificial intelligence, such as an entity which is trained for machine learning, for example by means of supervised learning, is then trained. Artificial intelligence can learn from examples and can generalize them after the end of the learning phase. For this purpose, for example algorithms in machine learning create a statistical model which is based on training data. This means that examples are not simply memorized, but rather patterns and regularities are recognized in the training data. Thus, artificial intelligence can also assess unknown data (learning transfer).

During the prediction phase, a set of binary control signals is now formed from the individual binary control signals and is used to activate or deactivate an ECU or a control function of this ECU. Thus, the actual control function of the ECU is not affected by the artificial intelligence; it is deactivated only in certain situations according to the set of binary control signals, which may also be interpreted as a set of rules.

According to one implementation, a simulation may be carried out in an X in the loop (XiL) environment during the simulation phase. The XiL environment may be for example a hardware in the loop (HiL) environment, a software in the loop (SiL) environment, or a model in the loop (MiL) environment. ECUs or hardware and/or software components of the ECU may thus be integrated.

According to a further implementation, archived operating data, in particular archived vehicle data and/or GPS data, may be used during the training phase. The archived operating data may be data or data sets which are transmitted via a motor vehicle-internal data bus, such as a CAN bus, while the GPS data may be data or data sets which are provided by the navigation device of the motor vehicle and which are indicative of a position of the motor vehicle. The training result may thus be improved.

According to further implementation, a recurrent neural network may be used as artificial intelligence. Artificial neural networks (ANNs) comprise a plurality of artificial neurons which, in the case of deep neural networks, are arranged in numerous hidden layers between an input layer and an output layer. Recurrent or feedback neural networks (RNNs) are neural networks which, in contrast to feedforward networks, are characterized by connections from neurons of one layer to neurons of the same layer or of a preceding layer. Thus, neurons of the same layer or of different layers are fed back. By means of these feedbacks, time-encoded information may be obtained from data.

The present disclosure further relates to a non-transitory computer-readable storage medium having stored thereon computer-executable instructions configured to perform the method, a system, an ECU for a motor vehicle, and a motor vehicle comprising such an ECU.

### BRIEF DESCRIPTION OF THE DRAWINGS

The present disclosure will now be explained with the aid of drawings. The following are shown:

FIG. 1 is a schematic diagram of components of a system for operating a motor vehicle.

FIG. 2 is a schematic diagram of an XiL environment of the system depicted in FIG. 1.

FIG. 3 is a schematic diagram of details of the artificial intelligence depicted in FIG. 1.

FIG. 4 is a flow diagram of an operating sequence of the system depicted in FIG. 1.

FIG. 5 is a schematic diagram of a method sequence for operating the system depicted in FIG. 1.

FIG. 6 is a flow diagram of details of the method sequence depicted in FIG. 5.

### DETAILED DESCRIPTION

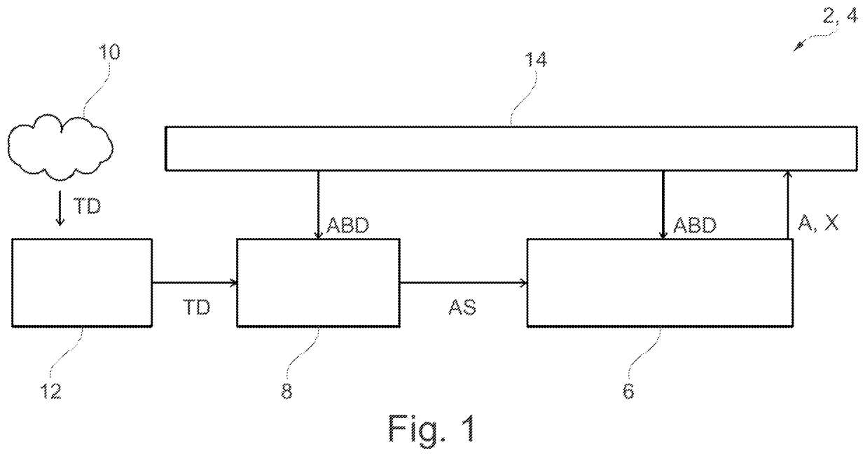

Reference will first be made to FIG. 1.

A system 2 for operating a motor vehicle 4 is depicted.

In the present example implementation, the motor vehicle 4 is designed as a passenger car and comprises an ECU 6 which controls a control function A and a system-critical control function X of a driver assistance system of the motor vehicle 2. The present disclosure is not limited to two control functions, and in other implementations, the ECU 6 may also control only a single control function or more than two control functions.

Further depicted components of the motor vehicle 4 include an artificial intelligence 8, a modem 12, and a CAN bus 14. Of the components of the system 2, a cloud 10 is shown in FIG. 1.

The ECU 6 reads in current operating data ABD of the motor vehicle 4 via the CAN bus 14 and evaluates said data in order then to actuate the control function A and/or the system-critical control function X of the driver assistance system, wherein an actuation signal is fed into the CAN bus 14 for this purpose.

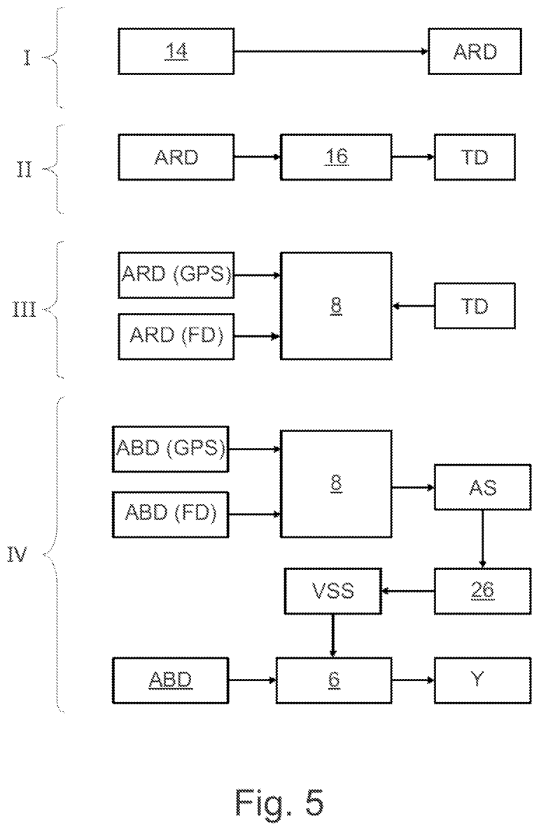

Furthermore, the system 2 is configured to acquire operating data of this motor vehicle 4 and also of other motor vehicles during an acquisition phase I (see FIG. 5) and to evaluate the archived operating data ARD during a simulation phase II (see also FIG. 5) in order to obtain labeled training data TD for the artificial intelligence 8, both of which will be explained in detail later. The artificial intelligence 8 may be designed as a unit or as a component with its own hardware and/or software components. In this case, the artificial intelligence is arranged in the motor vehicle 4, so that data processing is possible on site, i.e., in the motor vehicle 4.

In the present example implementation, the labeled training data TD are archived in the cloud 10 and can be read in wirelessly by means of the modem 12 and made available to the artificial intelligence 8 in order to train it during a training phase III (see also FIG. 5).

After the training phase III, during the prediction phase IV, the artificial intelligence 8 reads in current operating data ABD of the motor vehicle 4 via the CAN bus 14, evaluates said data, and provides a set of binary control signals as an output AS, which activate or deactivate the ECU 6 or its control function A and/or X.

Thus, the actual control functions A and/or X of the ECU 6 are not directly influenced by the artificial intelligence 8; it is deactivated only in certain situations according to the output AS.

Furthermore, the system 2 is configured to effect the activation or deactivation of the ECU 6 during a prediction phase IV (see also FIG. 5), as will also be explained in detail later.

For these tasks and control functions and the ones described below, the system 2, the motor vehicle 4, and their respective components may each comprise hardware and/or software components.

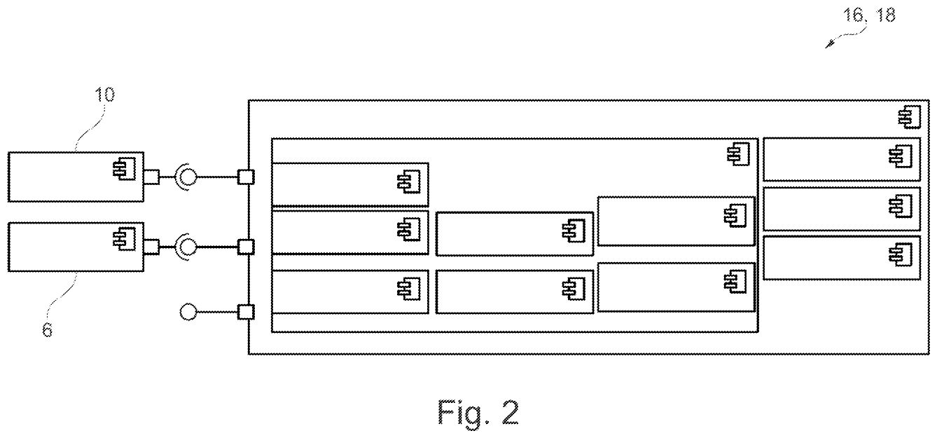

Reference will now be made additionally to FIG. 2.

An XiL environment 16 is depicted comprising a plurality of XiL components 18 for carrying out a simulation during simulation phase II, in order to evaluate the archived operating data ARD in the present example implementation, and thus to be able to provide labeled training data TD.

In the present implementation, monitored machine learning algorithms are used which require such data for classification tasks. The output data of the simulation, i.e., labeled data, may also be interpreted as control signals or “control flags” which activate or deactivate the ECU 6 or its control functions A and/or B.

If a control signal of the output AS has, for example, the value logical zero, a specific control function, for example A or X, would be deactivated in the control. However, if the value is logical one, the control function A or X is enabled. The number of control signals of the output AS depends on the number of control functions in the ECU 6.

The XiL environment 16 may for example be a hardware in the loop (HiL) environment, a software in the loop (SiL) environment, or a model in the loop (MiL) environment. Thus, the ECU 6 or hardware and/or software components of the ECU 6 can be integrated.

The XiL environment 16 has an interface to the cloud 10 and thus can read in the archived operating data ARD. The interface may for example be a USB, Ethernet, Wi-Fi interface, or also an interface to mobile networks (3G, 4G, 5G). The XiL environment 16 also stores the simulation results (controller flags) in the cloud 10. Instead of a cloud 10, a physical hard disk or other data storage device may be used.

The XiL simulations may be vehicle simulations and simulations of their subcomponents, including simulations of the powertrain, electrical/electronic architecture (E/E systems), frame, body, suspension, and steering system. Sensor simulation (for example LIDAR or RADAR systems, camera systems), traffic simulations, or driving environment simulations (in a virtual driving environment) may also be provided. A complete simulation system is not always necessary, since the acquired operating data BD contain most of the available signals of the ECU 6. As a result, it is not always necessary to simulate complete vehicle systems, but only those which are required for generating the control signals.

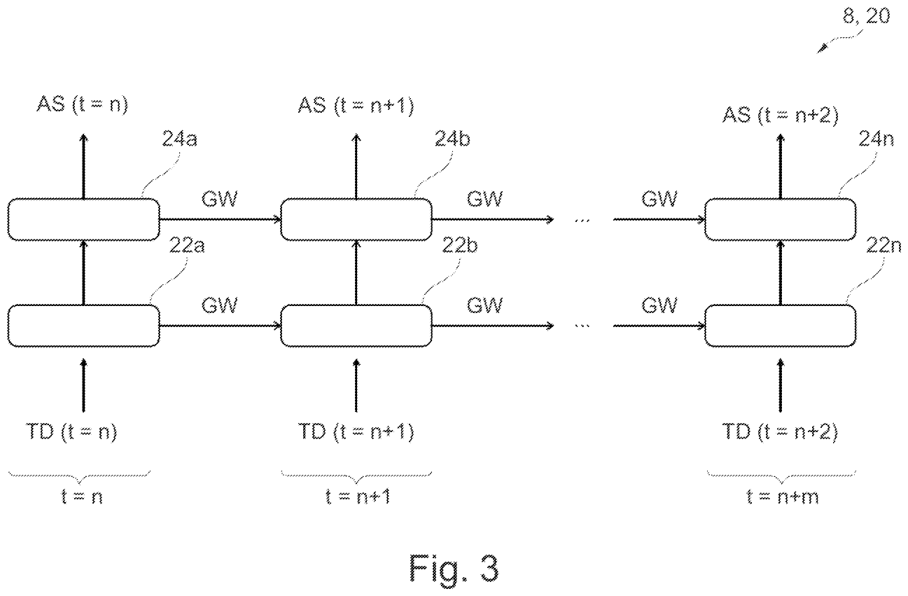

Reference will now be made additionally to FIG. 3.

A component of artificial intelligence 8 is depicted. In the present implementation, the artificial intelligence 8 includes an artificial neural network which is configured as a recurrent neural network.

Artificial neural networks, or ANNs, are networks of artificial neurons. These neurons (also called nodes) of an artificial neural network are arranged in layers and are generally interconnected in a fixed hierarchy. The neurons are usually connected between two layers, but in rare cases also within one layer.

Recurrent neural networks (RNNs) are artificial neural networks which, in contrast to feedforward neural networks, are characterized by connections from neurons of one layer to neurons of the same layer or of a preceding layer. Instead of recurrent neural networks, gated recurrent units (GRUs) or convolutional neural networks may also be used.

In this case, in the present example implementation, all neurons of a middle layer of the artificial neural network are long short-term memory (LSTM) cells 24a, 24b, . . . 24n, which are configured with an input logic gate, a forget logic gate, and an output logic gate in each case, and which are connected downstream of a respective input cell 22a, 22b, . . . 22n. Each LSTM cell 24a, 24b, . . . 24n is a neural network which contains a plurality of hidden layers.

The LSTM cells 24a, 24b, . . . 24n are used to transmit weight information GW to the respective next time t=n, n+1, . . . n+m. This weight information GW is representative of a cell state and a hidden state variable, resulting in a particularly robust neural network 20. The neural network 20 comprising the LSTM cells 24a, 24b, . . . 24n may also be configured to be bidirectional, so that a backpropagation algorithm for training runs in the forward and backward directions.

During the training phase III, the labeled training data TD are fed to the neural network 20 together with the control signals of the output AS determined during the simulation phase III. In the present example implementation, the training takes place by means of monitored learning. The neural network 20 thus learns from the simulation of the control signals of the output AS.

For this purpose, during the training phase III, the respective LSTM cells 24a, 24b, . . . 24n are supplied with the labeled training data TD and the associated control signals of the output AS at each time step, for example at time t=n, n+1, . . . n+m. In other words, the labeled training data TD is a plurality of data sets, wherein one data set is assigned to a time t=n, n+1, . . . n+m in each case.

In the prediction phase IV, a corresponding set of current operating data ABD is fed to the trained neural network 20. As an output signal AS, the neural network 20 provides a set of binary control signals, which may also be interpreted as a set of rules. In other words, the output AS is a plurality of data sets, wherein one data set is again assigned to a time t=n, n+1, . . . n+m in each case.

A complex artificial intelligence 8 could for example require a more computationally intensive neural network 20 in each LSTM cell 24a, 24b, . . . 24n. The length of the LSTM sequence would depend on the controller itself and the tasks which it performs. For example, the LSTM sequence could have a length of 10,000 ms with 100 ms time intervals, resulting in n=100 LSTM cells. An artificial intelligence 8 for an ECU 6 which receives inputs from an HMI control unit could require 1000 ms time intervals, while this may be 10 ms for a DAT control unit.

Thus, in the prediction phase IV, the trained neural network 20 is used to generate a prediction output. The prediction output is a list of values between 0 and 1. The prediction output is post-processed to generate a list of control signals which contains binary data with Boolean variables. Each control signal activates or deactivates a rule-based conventional control logic of the respective ECU 6.

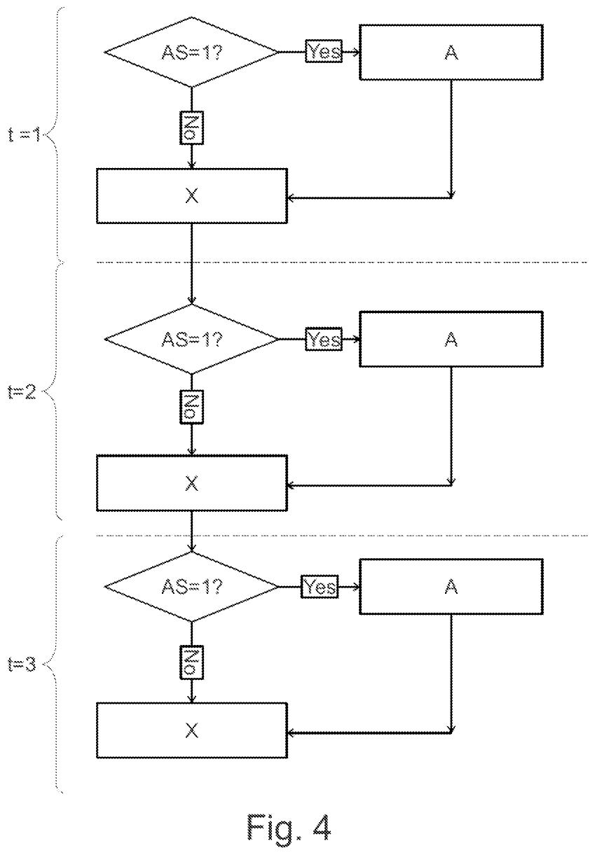

Reference will now be made additionally to FIG. 4.

The ECU 6 with artificial intelligence 8 is designed to execute the control function A and/or the system-critical control function X. The control function A is a location-based control function which is designed for specific GPS coordinates (for example on motorways).

While a conventional ECU 6 continuously executes the control function A and the control function X in a sequential order at each time step t1, t2, t3, the execution of the control function A in accordance with the present disclosure now depends on output AS. The control function A, on the other hand, is executed unchanged.

Reference is now made additionally to FIG. 5 in order to explain a method sequence for operating the system 2.

The method begins with the acquisition phase I, during which operating data of the motor vehicle 4 and also of other motor vehicles are acquired.

The operating data are read out for example via the CAN bus 14 and archived in the cloud 10 as archived operating data ARD.

Thus, the operating data or archived operating data ARD may be GPS data GPS and corresponding vehicle data FD of the motor vehicle 4. The GPS data GPS include, for example, data which are representative of the speed of the motor vehicle 4, the latitude and longitude coordinates of the motor vehicle 4, the acceleration of the motor vehicle 4, time information (UTC), trip information (start of trip, end of trip, trip number), and the state of the motor vehicle 4 (moving/parked). The vehicle data FD include, for example, communication information from the CAN bus 14 of the motor vehicle 4 or from other networks (for example high and low speed CAN data, 3G, 4G, 5G data). This may include, for example, data from the engine ECU (for example engine temperature, torque) or from DAT sensors (for example type of road, traffic signs, speed limits), as well as from an HMI unit (weather, frequency of travel, duration of travel, destination locations). The data may also include the output of the target controller to be optimized. The data are also recorded as a time sequence.

During the simulation phase II, the archived operating data ARD are evaluated in order to obtain the labeled training data TD for training the artificial intelligence 8. For this purpose, a simulation is carried out in an XiL environment 16 during the simulation phase II. In this case, the artificial intelligence 8 uses a recurrent neural network.

During the training phase III, the artificial intelligence 8 is trained with the labeled training data TD. In addition, archived operating data ARD, in particular recorded vehicle data FD and/or GPS data GPS such as archived GPS data GPS and vehicle data FD, are used for training during the training phase III.

During the prediction phase IV, the trained artificial intelligence 8 is supplied with current operating data ABD, in particular current GPS data GPS and vehicle data FD. The ECU 6 of the motor vehicle 4 is then activated or deactivated by the artificial intelligence 8 according to the output AS provided by the artificial intelligence 8.

The output AS is then fed to data post-processing in a data processing unit 26, which provides a prediction control signal VSS. The prediction control signal VSS may be a list of control signals which contains binary data with Boolean variables.

The prediction control signal VSS is then fed together with current operating data ABD to the ECU 8, which then activates or deactivates the control function A and/or the control function X according to an optimized output Y.

In other words, a control function f (A, X)=Y is executed, wherein current operating data ABD, in particular current GPS data GPS and vehicle data FD, are supplied to the control functions A and X as an input in each case.

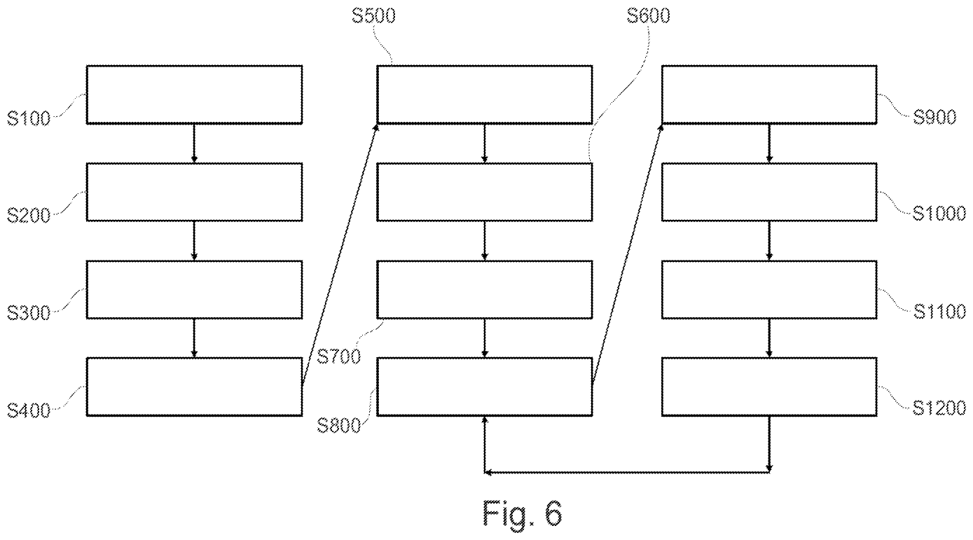

Reference is now made additionally to FIG. 6 in order to explain further details of the method sequence.

In FIG. 6, the first step S100 is carried out during the acquisition phase I, steps S200 to S600 are executed during the simulation phase II and the training phase III, and steps S700 to S1200 are executed during the prediction phase IV.

In step S100, operating data ARD is acquired and archived.

In step S200, the operating data ARD archived during step S100 are supplied to the XiL environment 16, and in further step S300, the simulation is carried out and the simulation results are temporarily stored in the cloud 10.

In a further step S400, the recurrent neural network of the artificial intelligence 8 is configured, and in a further step S500, the artificial intelligence 8 in the present example implementation is trained in the cloud 10. In a further step S600, the ECU 8 is adjusted according to the results of the simulation.

In a further step S700, current operating data ARD are read in, and in a further step S800, the trained artificial intelligence 8 is supplied with current operating data ARD in order to obtain the output AS.

In a further step S900, the prediction control signal VSS is provided, which is transmitted to the ECU 6 in a further step S1000.

In a further step S1000, the ECU 6 reads in current operating data ABD and then uses the prediction control signal VSS to provide an optimized output according to which the control function A and/or the control function X are activated or deactivated.

Furthermore, during the prediction phase IV, it may be provided to evaluate the activation or deactivation of the ECU 6 of the motor vehicle 4 by means of the artificial intelligence 8 for further training of the artificial intelligence 6. For this purpose, the artificial intelligence 8 is supplied with data which are indicative of an activated or deactivated ECU 6, or activated or deactivated control functions A and/or X.

Without departing from the scope of the present disclosure, in one or more implementations, the sequence of the steps may also be different. Furthermore, several steps may also be carried out at the same time or simultaneously. Furthermore, in other implementations, individual steps may be also skipped or omitted.

Advantageously, the control functions A and X of the ECU 6 are retained in full.

### LIST OF REFERENCE SIGNS

2 System
4 Motor vehicle
6 ECU
8 Artificial intelligence
10 Cloud
12 Modem
14 CAN bus
16 XiL environment
18 XiL component
20 Neural network
22a Input cell
22b Input cell
22n Input cell
24a LSTM cell
24b LSTM cell
24n LSTM cell
26 Data processing unit
A Control function
ABD Current operating data
ARD Archived operating data
AS Output
FD Vehicle data
GPS GPS data
GW Weight information
TD Training data
VSS Prediction control signal
X Control function
Y Optimized output
t1 Time step
t2 Time step
t3 Time step
t=n Point in time
t=n+1 Point in time
t=n+m Point in time
I Acquisition phase
II Simulation phase
III Training phase
IV Prediction phase
S100 Step
S200 Step
S300 Step
S400 Step
S500 Step
S600 Step
S700 Step
S800 Step
S900 Step
S1000 Step
S1100 Step
S1200 Step

1-11. (canceled)

12. A method for operating a motor vehicle, comprising:
acquiring current operating data during an acquisition phase to obtain archived operating data;
evaluating the archived operating data during a simulation phase to obtain labeled training data for an artificial intelligence;
training the artificial intelligence with the labeled training data during a training phase; and
activating or deactivating an electronic control unit (ECU) or a control function of the ECU of the motor vehicle with the artificial intelligence during a prediction phase.

13. The method of claim 12, wherein a simulation is carried out in an X in the loop (XiL) environment during the simulation phase.

14. The method of claim 12, wherein the archived operating data include archived vehicle data and/or archived global positioning system (GPS) data, and the archived operating data are additionally used during the training phase.

15. The method of claim 12, wherein a recurrent neural network is used as the artificial intelligence.

16. A non-transitory computer-readable storage medium having stored thereon computer-executable instructions configured to cause a processor to perform operations to:
acquire current operating data during an acquisition phase to obtain archived operating data;
evaluate the archived operating data during a simulation phase to obtain labeled training data for an artificial intelligence;
train the artificial intelligence with the labeled training data during a training phase; and
activate or deactivate an electronic control unit (ECU) or a control function of the ECU of the motor vehicle with the artificial intelligence during a prediction phase.

17. A system for operating a motor vehicle comprising a processor and a memory, the memory storing instructions executable by the processor, the instructions including instructions to:
acquire current operating data during an acquisition phase to obtain archived operating data;
evaluate the archived operating data during a simulation phase to obtain labeled training data for an artificial intelligence;
train the artificial intelligence with the labeled training data during a training phase; and
activate or deactivate an electronic control unit (ECU) or a control function of the ECU of the motor vehicle with the artificial intelligence during a prediction phase.

18. The system of claim 17, wherein the instructions include instructions to carry out a simulation in an X in the loop (XiL) environment during the simulation phase.

19. The system of claim 17, wherein the instructions include instructions to use archived operating data during the training phase, wherein the archive operating data include archived vehicle data and/or archived global positioning system (GPS) data.

20. The system of claim 17, wherein the artificial intelligence includes a recurrent neural network.

21. The system of claim 17, further including the ECU.

22. A motor vehicle including the system of claim 21.
